(19) United States
(12) Patent Application Publication
(10) Pub. No.: US 2015/0288203 A1
(43) Pub. Date: Oct. 8, 2015

(54) PORTABLE BATTERY CHARGER

(71) Applicant: Sang Hyun Ahn, Suwon-si (KR)

(72) Inventor: Sang Hyun Ahn, Suwon-si (KR)

(21) Appl. No.: 14/364,091

(22) PCT Filed: Mar. 31, 2014
(86) PCT No.: PCT/KR2014/002743

§ 371 Date: Jun. 10, 2014

(51) Int. Cl. H02J 7/00

(52) U.S. Cl. CPC H02J 7/0042; H02J 7/0052; H02J 2007/0062

(57) ABSTRACT

A portable battery charger, which can be kept in a neatly arranged state with a wound cable, thereby being easily and efficiently carried, and in which both a contact terminal of a connector that will be connected to a mobile phone and pin terminals of a charging adapter are hidden from the outside, thereby being efficiently protected. In the battery charger, the connector and the charging adapter are configured to be combined with each other, and a cable winding part on which the cable will be wound is formed on a portion at which the connector and the charging adapter face each other, so the cable can be kept in a neatly arranged state, and the contact terminal can be protected by being hidden from the outside, thus the charger can prevent contamination of the contact terminal by impurities and can prevent breakage of the contact terminal by external shock.

### TECHNICAL FIELD

The present invention relates, in general, to a mobile phone charger and, more particularly, to a portable battery charger, which can be kept in a neatly arranged state with a wound cable, thereby being easily and efficiently carried, and in which both a contact terminal of a connector that will be connected to a mobile phone and pin terminals of a charging adapter are hidden from the outside, thereby being efficiently protected.

### BACKGROUND ART

According to developments in communication technology, various kinds of communication devices have been proposed and are being used. Especially, in recent years, the use of mobile communication devices has rapidly increased.

Such mobile communication devices are devices that are operated by electricity, and typically use rechargeable batteries, in which the batteries can be repeatedly recharged using battery chargers. To charge an electronic device, such as the mobile communication device, with electricity, a battery charger connected to an external power source is typically used. Here, the external power source may be an AC power source, and the battery charger charges the electronic device with electricity while converting the AC voltage of the AC power source into a DC voltage using a converter.

Battery chargers for mobile communication devices are typically classified into two types: a battery charger designed to charge a battery removed from the mobile communication device, and a battery charger designed to be directly connected to a mobile communication device and charge a battery installed in the mobile communication device. An example of technologies relating to conventional battery chargers designed to charge an electronic device with electricity by being directly connected to a mobile communication device may be referred to Patent Document 1.

Patent Document 1 discloses a battery charging system, including: a TTA 24-pin charger; a mobile communication device having an input terminal that receives an increased voltage as an input power, in which the increased voltage received by the input terminal is higher than an input voltage supplied from the TTA 24-pin charger, and a battery of the device is charged with electricity using the increased voltage input by the input terminal; and a charging gender that has a first interface part connected to a connector of the TTA 24-pin charger, and a second interface part connected to a micro USB terminal or a firewire terminal of the mobile communication device, in which the charging gender outputs an increased voltage formed by boosting an input voltage input by the first interface part to the micro USB terminal or the firewire terminal of the mobile communication device via the second interface part.

As shown in FIG. 6, the conventional battery charger typically includes a connector 100 having a contact terminal 100t that is connected to a charging terminal of a mobile communication device, and a charging adapter 200 that is connected to the connector 100 by a cable 300 and is detachably inserted into a commercial voltage socket.

The conventional battery charger having the above-mentioned construction is problematic in that the cable extends between the connector and the charging adapter, as shown in the drawing, so, when carrying the charger, the cable may be easily caught by or entangled with another article, thereby being inconvenient for the user to carry the charger, and when keeping the charger, the cable may be in disorder without being neatly arranged, thereby creating a disheveled appearance.

Another problem of the conventional battery charger resides in that impurities may be easily held in the contact hole formed in the contact terminal of the connector, and may disturb the contact terminal from coming into effective contact with the charging terminal of the mobile communication device or may cause a failure in charging the battery with electricity.

### DOCUMENTS OF RELATED ART

### Patent Document

(Patent Document 1) Korean Patent Application Publication No. 2012-0032377

### DISCLOSURE

### Technical Problem

Accordingly, the present invention has been made keeping in mind the above problems occurring in the related art, and the present invention is intended to propose a portable battery charger which can be easily and efficiently kept and carried in a compact state with a cable neatly arranged and a contact terminal efficiently protected by being hidden from the outside.

Described in detail, the present invention is intended to propose a portable battery charger, in which a connector and a charging adapter are configured to be combined with each other, and a cable winding part on which the cable can be wound is formed on a portion at which the connector and the charging adapter face each other, so the cable can be kept in a neatly arranged state, and the contact terminal can be efficiently protected by being hidden from the outside, thus the present invention can prevent contamination of the contact terminal by impurities and can prevent breakage of the contact terminal by external shock.

### Technical Solution

In order to achieve the above object, according to one aspect of the present invention, there is provided a portable battery charger, including: a connector having a contact terminal that will be connected to a mobile electronic device; and a charging adapter connected to the connector by a cable and having a pin terminal that protrudes from the charging adapter so as to be connected to a terminal of a socket, further including: a cable winding part for allowing the cable to be wound thereon, the cable winding part being formed on either the connector or the charging adapter at a location at which the connector or the charging adapter faces the other; and a pin terminal insert hole into which the pin terminal will be removably inserted, and a terminal seat into which the contact terminal will be inserted, the pin terminal insert hole and the terminal seat being formed on facing surfaces of the connector and the charging adapter.

The cable may have a coiled shape corresponding to the shape of the outer circumferential surface of the cable winding part, so the cable can be easily wound around the cable winding part.

### Advantageous Effects

As described above, the portable battery charger according to the present invention is advantageous in that the cable can be neatly arranged by being wound around a cable winding part, thereby realizing a good appearance of the charger and minimizing the size of the charger, thus allowing a user to easily carry the charger.

### DESCRIPTION OF DRAWINGS

FIG. 1 is a perspective view of a portable battery charger according to a first embodiment of the present invention;

FIG. 2 is a perspective view of a portable battery charger according to a second embodiment of the present invention;

FIG. 3 is a perspective view of a portable battery charger according to a third embodiment of the present invention;

FIG. 4 is a perspective view of a portable battery charger according to a fourth embodiment of the present invention;

FIG. 5 is a perspective view illustrating a portable battery charger according to the present invention when the charger is compacted to be carried; and

FIG. 6 is a perspective view of a conventional portable battery charger.

### BEST MODE

The present invention may be variously modified and may be embedded in a variety of embodiments, preferred examples of which will be shown in the accompanying drawings for illustrative purposes and will be described in detail with reference to the drawings. However, it should be understood that the present invention is not limited by the embodiments, and various modifications, additions and substitutions are possible, without departing from the scope and spirit of the invention.

In the following description with reference to the accompanying drawings, it is to be noted the same reference numerals are used throughout the different drawings to designate the same or similar components and that, when the functions of conventional elements and the detailed description of elements related with the present invention may make the gist of the present invention unclear, a detailed description of those elements will be omitted.

In a battery charger according to the present invention, a cable can be neatly arranged by being wound, so the charger can be easily and efficiently kept and carried, and can efficiently protect a contact terminal thereof.

The battery charger of the present invention includes a cable winding part 20w around which the cable 30 can be wound.

Like a conventional battery charger, the battery charger according to the present invention is formed by connecting a connector 10, which will be connected to a mobile electronic device, such as a mobile communication device, when charging the device, to a charging adapter 20 by the cable 30.

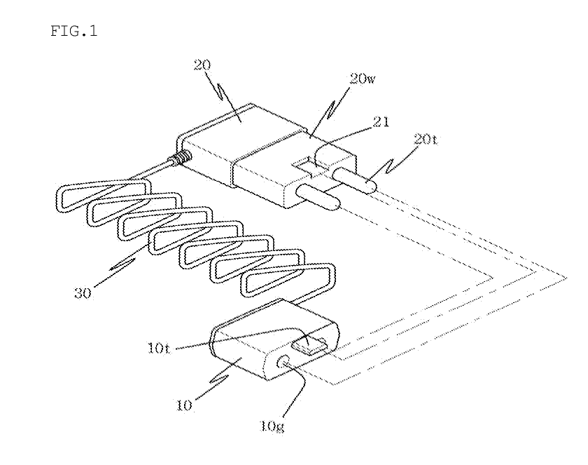

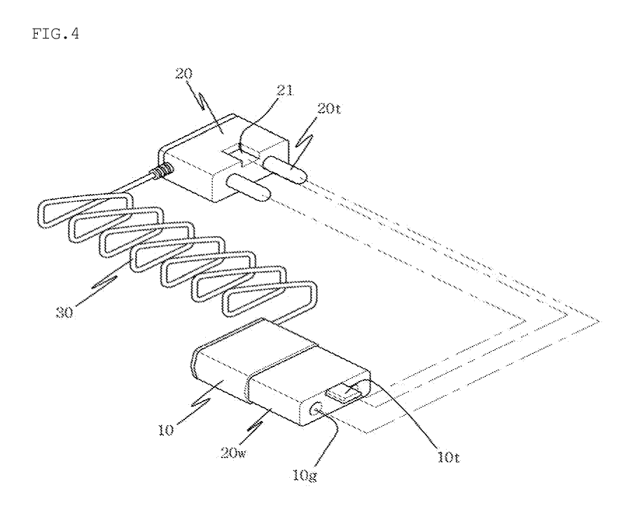

Here, the cable winding part 20w may be formed on a predetermined portion of the charging adapter 20 as shown in FIGS. 1 to 3, or may be formed on a predetermined portion of the connector 10 as shown in FIG. 4. Of the two embodiments, it is preferred that the cable winding part 20w be formed on a predetermined portion of the charging adapter 20, as shown in the drawings. Further, it is preferred that the charging adapter 20 has a sufficient volume to allow a user to easily hold the charging adapter 20 by hand when connecting or removing the charging adapter 20 to or from a commercial voltage socket. In addition, it is required to configure the volume of the charging adapter 20 larger than that of the connector 10, so the cable winding part 20w is formed on the charging adapter 20 in an effort to reduce the size of the connector 10 compared to that of the charging adapter 20.

Further, as shown in the drawings, the width and thickness of the cable winding part 20w are designed to be smaller than those of the other parts of the charging adapter 20, so the wound cable 30 can be prevented from protruding outside the surface of the charging adapter and from being removed from the cable winding part 20w.

As shown in FIGS. 1 to 5, the connector 10 to which the cable 30 is connected further includes a contact terminal 10t that protrudes from an end of the connector 10 such that the terminal 10t can be connected to a charging terminal of a mobile electronic device, such as a mobile communication device. Here, the connector 10 is configured to have the same or similar sectional area compared to that of the charging adapter 20, as shown in the drawings.

Further, pin terminal insert holes 10g are formed in a surface of the connector 10 from which the contact terminal 10t protrudes, so pin terminals 20t of the charging adapter 20 can be inserted into the pin terminal insert holes 10g and, when the charging adapter 20 is combined with the connector 10, the pin terminals 20t can be hidden from the outside. The inner diameters of the pin terminal insert holes 10g are equal to the outer diameters of the pin terminals 20t, so, when the pin terminals 20t are inserted into the pin terminal insert holes 10g, the pin terminals 20t are prevented from being undesirably removed from the pin terminal insert holes 10g unless an external force is applied thereto.

As shown in FIGS. 1 to 3, the cable winding part 20w is formed on the housing of the charging adapter 20 in such a way that the cable winding part 20w is depressed to be lower than the other parts of the charging adapter 20, so the wound cable 30 is not undesirably removed from the cable winding part 20w.

Further, a terminal seat 21 is formed on the charging adapter 20, so the contact terminal 10t of the connector can be seated in the terminal seat 21.

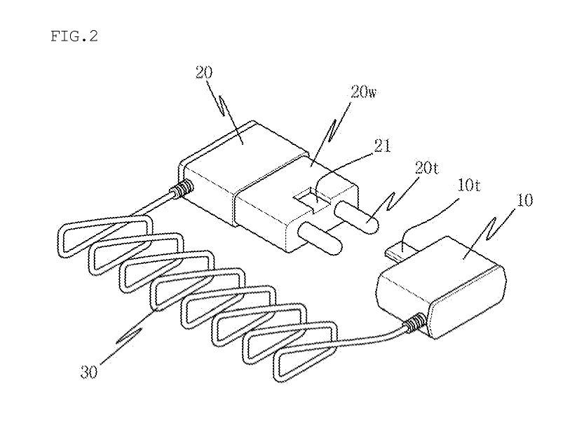

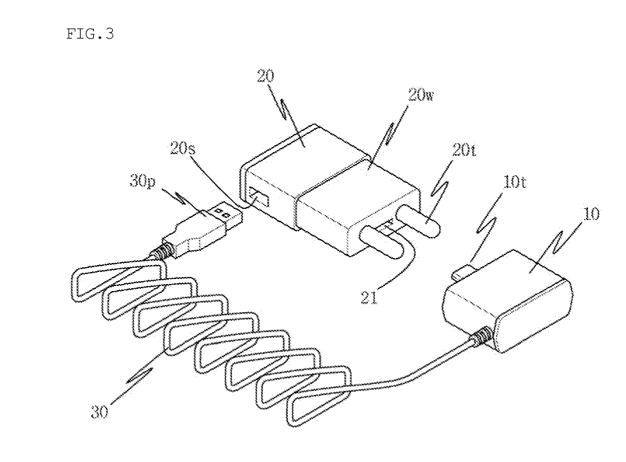

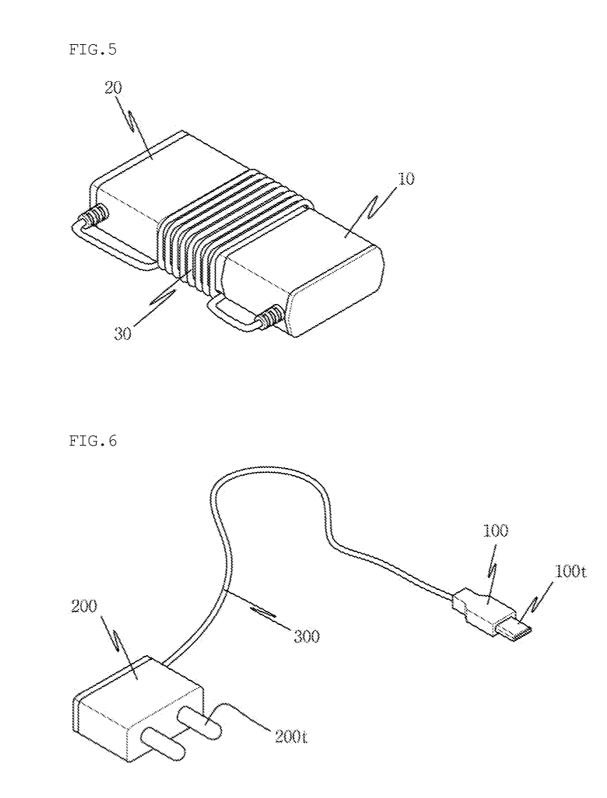

The terminal seat 21 may be configured as a depression formed on a surface of the charging adapter 20 as shown in FIGS. 1 and 2, or as a hole formed in the center of an end surface of the charging adapter 20 as shown in FIG. 3. Of course, the contact terminal 10t that will be seated in the terminal seat 21 is formed on the connector 10 at a location corresponding to the terminal seat 21 when the connector 10 is combined with the charging adapter 20 as shown in FIG. 5. Further, it is preferred that the cross-sectional area of the terminal seat 21 be larger than that of the contact terminal 10t so that the contact terminal 10t can be easily seated in and easily removed from the terminal seat 21.

As described above, the battery charger according to the present invention is configured such that the cable can be easily and neatly arranged. Here, to allow the cable to be easily and closely wound around the cable winding part 20w and to prevent the wound cable from being undesirably removed from the cable winding part 20w, the cable 30 may have a spirally coiled shape corresponding to a shape of the outer circumferential surface of the cable winding part 20w.

In the present invention, the mobile electronic device, for example, a mobile communication device, may be configured such that the device can be charged using a USB port of a computer, and the charging adapter 20 may be omitted from the portable battery charger.

In this case, a USB socket 20s may be formed in the charging adapter 20 and a USB plug 30p may be provided on an end of the cable 30 such that the USB plug 30p can be removably inserted into the USB socket 20s. Accordingly, the cable 30 may be connected to the charging adapter 20 when necessary.

Although the preferred embodiments of the present invention have been disclosed for illustrative purposes, those skilled in the art will appreciate that the present invention is not limited by the embodiments, and various modifications, additions and substitutions are possible, without departing from the scope and spirit of the invention as disclosed in the accompanying claims.

Accordingly, it is noted that the scope and spirit of the invention should not be limitedly defined by the embodiments, but will be defined by the accompanying claims and by modifications that are equal or equivalent to the claims.

Further, although the mobile phone charger have been disclosed for ease of description, those skilled in the art will appreciate that the present invention can be adapted to all the battery chargers of mobile electronic devices.

[Description of the Reference Numerals in the Drawings]

| | |
|---|---|
| 10: connector | 10g: pin terminal insert hole |
| 10t: contact terminal | 20: charging adapter |
| 20t: pin terminal | 20s: USB socket |
| 20w: cable winding part | 21: terminal seat |
| 30: cable | 30p: USB plug |

1. A portable battery charger comprising: a connector (10) having a contact terminal (10t) that will be connected to a mobile electronic device; and a charging adapter (20) connected to the connector by a cable (30) and having a pin terminal (20t) that protrudes from the charging adapter so as to be connected to a terminal of a socket, further comprising: a cable winding part (20w) for allowing the cable to be wound thereon, the cable winding part being formed on either the connector (10) or the charging adapter (20) at a location at which the connector or the charging adapter faces the other; and
a pin terminal insert hole (10g) into which the pin terminal will be removably inserted, and a terminal seat (21) into which the contact terminal (10t) will be inserted, the pin terminal insert hole and the terminal seat being formed on facing surfaces of the connector (10) and the charging adapter (20).

2. The portable battery charger according to claim 1, wherein the cable (30) has a coiled shape corresponding to a shape of an outer circumferential surface of the cable winding part (20w).

3. The portable battery charger according to claim 1, wherein the charging adapter (20) is provided with a USB socket (20s) and the cable (30) is provided on an end thereof with a USB plug (30p) that will be removably connected to the USB socket.

4. The portable battery charger according to claim 1, wherein the cable winding part (20w) is formed on the charging adapter (20).

5. The portable battery charger according to claim 1, wherein the terminal seat (21) has a depression shape or a hole shape.
